(19) United States
(12) Patent Application Publication
(10) Pub. No.: US 2025/0052924 A1
(43) Pub. Date: Feb. 13, 2025

(54) ROCK PROPERTY MEASUREMENTS BASED ON SPECTROSCOPY DATA

(71) Applicant: Schlumberger Technology Corporation, Sugar Land, TX (US)

(72) Inventors: Paul Ryan Craddock, Cambridge, MA (US); Jeffrey Miles, Cambridge, MA (US); Lalitha Venkataramanan, Cambridge, MA (US); Harish Baban Datir, Stavanger (NO); Prakhar Srivastava, Gujarat (IN)

(21) Appl. No.: 18/723,648

(22) PCT Filed: Jan. 5, 2023
(86) PCT No.: PCT/US2023/010163

§ 371 Date: Jun. 24, 2024

Related U.S. Application Data
(60) Provisional application No. 63/266,425, filed on Jan. 5, 2022.

(51) Int. Cl. G01V 5/10; E21B 49/00

(52) U.S. Cl. CPC G01V 5/101; E21B 49/00; E21B 2200/22

(57) ABSTRACT

Rock properties of a geological formation may be determined using data representing elemental concentration within the geological formation. For example, the data representing the elemental concentration within the geological formation may be provided as input to a mapping function. The mapping function may capture nonlinear relationships among the concentrations of measurable elements in geological rock formation(s) and certain rock properties of said rock formation(s). Embodiments of the present disclosure are directed to techniques that improve determinations of rock properties of geological formations.

### CROSS-REFERENCE TO RELATED APPLICATIONS

This application claims the benefit of U.S. Provisional Application No. 63/266,425 entitled “Rock Property Measurements Based on Spectroscopy Data,” filed Jan. 5, 2022, the disclosure of which is incorporated herein by reference in its entirety.

### BACKGROUND

The present disclosure generally relates to determining rock properties of geological formations using elemental concentration data.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological formation is a remarkably complex endeavor. In many cases, exploration, appraisal, and decisions involved in hydrocarbon exploration and production may be informed by measurements from downhole well-logging tools that are conveyed deep into the wellbore. The measurements may be used to infer properties and characteristics of the geological formation (e.g., earth formation) surrounding the wellbore. Rock properties (e.g., matrix properties) of the geological formation may be used in the interpretation and determination of measurements made by the well-logging tools (e.g., well logging measurements). Accordingly, improving the accuracy of determining the rock properties may positively influence the exploration, appraisal, and decisions involved in hydrocarbon exploration and production.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is an example of a well logging spectroscopy system, in accordance with embodiments of the present disclosure;

FIG. 2 illustrates a flow chart of a method for determining a rock property output based on a mapping function, in accordance with embodiments of the present disclosure;

FIG. 3 illustrates plots of elemental concentrations, in accordance with embodiments of the present disclosure;

FIG. 4 shows an embodiment of an artificial neural network (ANN) that may be used in the method of FIG. 2, in accordance with embodiments of the present disclosure;

FIG. 5 shows graphs depicting a determination of grain density using a nonlinear and a linear mapping function, in accordance with embodiments of the present disclosure;

FIG. 6 shows graphs depicting a determination of matrix sigma using a nonlinear and a linear mapping function, in accordance with embodiments of the present disclosure; and

FIG. 7 illustrates plots of a prediction of magnesium concentration, in accordance with embodiments of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Rock properties (e.g., matrix properties) may influence a bulk formation response of well-logging measurements, and as such, it may be desirable to determine accurate rock properties to accurately interpret well-logging measurements with respect to certain formation properties, such as porosity, saturation, and permeability. For example, a rock property such as the matrix grain density may be used to provide an accurate determination of formation porosity using the measurement of formation bulk density. At least in some instances, certain rock properties may be difficult to measure directly or otherwise unobtainable and may be inferred from other measurable characteristics of the rock, such as elemental concentrations measured by downhole neutron spectroscopy, such as neutron-induced gamma-ray spectroscopy. Neutron-induced gamma-ray spectroscopy may be used to derive certain rock characteristics of a formation based on elemental concentrations within a geological formation. In neutron-induced gamma ray spectroscopy, fast neutrons and thermal neutrons generated from a naturally radioactive material or pulsed-neutron generator contained within the housing of the logging sonde (e.g., a portion of a well-logging tool that includes sensors) may interact with elemental nuclei in a geological formation and produce gamma radiation from inelastic nuclear reactions and neutron-capture reactions in a local volume surrounding the logging sonde. The produced gamma rays traverse the geological formation, and some of the gamma rays are detected by a detector (e.g., sensor) contained within the housing of the logging sonde. The detector signal is used to produce spectra indicating contributions from gamma rays representing the elemental nuclei in the formation. Gamma ray spectra associated with inelastic scattering and with thermal-neutron capture can be quantified separately. Inelastic and capture spectra may be plotted as count rate versus energy. The spectra contain information about the element identity (i.e., from the characteristic energies of the gamma rays) and about the element concentration (i.e., from the number or relative number of counts).

In any case, a mathematical method may be utilized to quantitatively estimate or infer certain rock properties (e.g., matrix properties) directly from elemental concentrations associated with certain elements such as silicon, calcium, iron, magnesium, and sulfur. These rock properties include, for example, one or more mineral concentrations in the rock matrix, matrix grain density, matrix neutron porosity response, and aluminum concentration in the rock matrix. One mathematical method for estimating rock properties uses linear regressions. For example, the matrix grain density may be estimated based on equation (Eq.) (1) below:

$${ρ}_{matrix} = 2.62 + 0.049 Si + 0.2274 \cdot Ca + 1.993 \cdot Fe + 1.193 \cdot S , \qquad ( Eq . 1 )$$

Further, aluminum concentration may be estimated based on Eq. 2:

$$Al = 0.34 \cdot ( 100 - 2.139 \cdot Si - 2.497 \cdot Ca - 3.468 \cdot Mg - 1.99 \cdot Fe ) , \qquad ( Eq . 2 )$$

At least in some instances, linear functions (e.g., Eq. 1 and Eq. 2) may not accurately capture certain mappings (e.g., a nonlinear mapping) that exists among the input(s) and output(s) in complex geological rock formations. Further, the linear functions may be based on assumptions regarding geochemical relationships among the measurable and interpreted features, which may limit their application. For example, the emulation of aluminum in Eq. 2 assumes calcium and magnesium are associated only with calcite, CaCO₃, and dolomite, (Ca,Mg)CO₃ (e.g., which does not apply in petroliferous formations containing, for example, anhydrite, CaSO₄). The expression of Eq. 2 can be extended in a multi-step routine to adjust calcium for the presence of anhydrite, but such corrections may utilize assumptions about the allocation of elements among minerals. Moreover, existing linear regression models may not incorporate any estimate of the uncertainty on the estimated rock property that arises from the model parameters. Accordingly, the present disclosure is directed to techniques for determining the rock properties of a geological formation using a model to capture nonlinear relationships among the concentrations of measurable elements in geological rock formation(s) and certain rock properties of said rock formation(s).

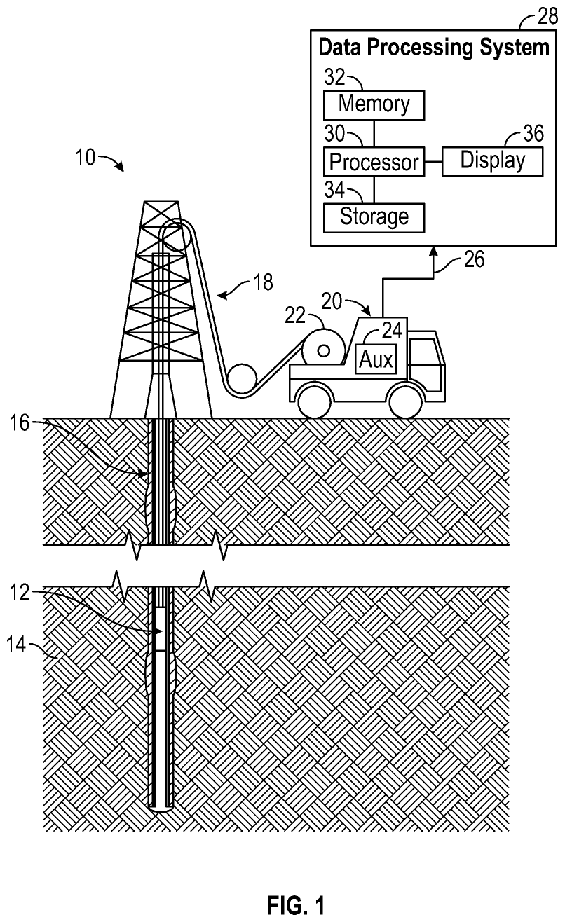

With the foregoing in mind, FIG. 1 illustrates a well-logging system 10 that may employ the systems and methods of this disclosure. The well-logging system 10 may be used to convey a downhole tool 12 through a geological formation 14 via a borehole 16. In the example of FIG. 1, the downhole tool 12 is conveyed on a cable 18 via a logging winch system (e.g., vehicle 20). Although the vehicle 20 is schematically shown in FIG. 1 as a mobile logging winch system carried by a truck, the vehicle 20 may be substantially fixed (e.g., a long-term installation that is substantially permanent or modular). Any suitable cable 18 for well logging may be used. The cable 18 may be spooled and unspooled on a drum 22 and an auxiliary power source 24 may provide energy to the vehicle 20 and/or the downhole tool 12.

Moreover, while the downhole tool 12 is described as a wireline downhole tool, it should be appreciated that any suitable conveyance may be used. For example, the downhole tool 12 may instead be conveyed as a logging-while-drilling (LWD) tool as part of a bottom hole assembly (BHA) of a drill string, conveyed on a slickline or via coiled tubing, and so forth. For the purposes of this disclosure, the downhole tool 12 may be any suitable downhole tool that uses neutron-induced gamma-ray spectroscopy within the borehole 16 (e.g., downhole environment). The gamma-ray spectroscopy may include, but is not limited to, inelastic, capture, or delayed activation gamma-ray spectroscopy. For example, the gamma-ray spectroscopy may include any suitable neutron-induced gamma-ray spectroscopies.

As discussed further below, the downhole tool 12 may receive energy from an electrical energy device or an electrical energy storage device, such as the auxiliary power source 24 or another electrical energy source to power the tool. Additionally, in some embodiments the downhole tool 12 may include a power source within the downhole tool 12, such as a battery system or a capacitor to store sufficient electrical energy to activate the neutron emitter and record gamma-ray radiation.

Data signals 26 may be transmitted from a data processing system 28 to the downhole tool 12, and the data signals may be related to the spectroscopy results may be returned to the data processing system 28 from the downhole tool 12, additionally, the data signals 26 may include control signals. The data processing system 28 may be any electronic data processing system that can be used to carry out the systems and methods of this disclosure. For example, the data processing system 28 may include a processor 30, which may execute instructions stored in memory 32 and/or storage 34. As such, the memory 32 and/or the storage 34 of the data processing system 28 may be any suitable article of manufacture that can store the instructions. The memory 32 and/or the storage 34 may be read-only memory (ROM), random-access memory (RAM), flash memory, an optical storage medium, or a hard disk drive, to name a few examples. A display 36, which may be any suitable electronic display, may display images generated by the processor 30. The data processing system 28 may be a local component of the vehicle 20 (e.g., within the downhole tool 12), a remote device that analyzes data from other vehicles 20, a device located proximate to the drilling operation, or any combination thereof. In some embodiments, the data processing system 28 may be a mobile computing device (e.g., tablet, smart phone, or laptop) or a server remote from the vehicle 20.

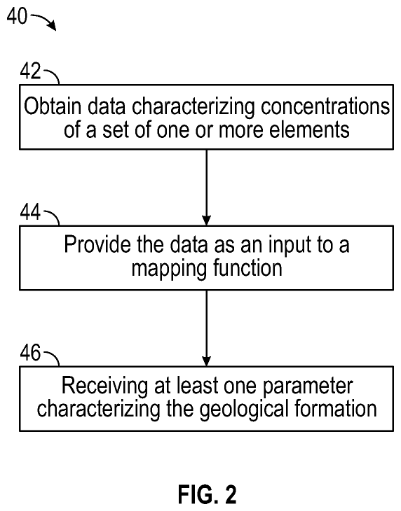

FIG. 2 illustrates a flow chart of a method 40 for determining a rock property output based on a mapping function. Although the method 40 is described as being performed by the processor 30, it should be noted that any suitable computer device capable of communicating with other components of the well-logging system 10 or the downhole tool 12.

With this in mind, and referring now to FIG. 2, at block 42, the processor 30 may acquire or obtain data indicating a set of one or more elemental concentrations in a geological formation. In some embodiments, the processor 30 may receive data acquired by one or more downhole tools 12 for a geological formation. In some embodiments, the processor 30 may output a control signal that causes one or more downhole tools 12 to operate and acquire the data indicating the set of one or more elemental concentrations. For example, the data may be data acquired by a neutron-induced gamma ray spectroscopy logging tool. In some embodiments, the data may characterize elemental concentrations associated with Si, Al, Ca, Mg, K, Fe, Na, Ti, P, Mn, S, Sr, Gd, B, Cl, C, O, H, or a combination thereof. In some embodiments, the geological formation may be a rock sample of the geological formation, such as a rock chip, a rock core, a rock drill cutting, and/or a rock outcrop.

In some embodiments, the mapping function is derived from a minimization of a cost function given a set of data including input data, output data, uncertainties in the input data, missing data, and data of different fidelities as captured by their uncertainties. The cost function may include a mean squared error function, a least squares error function, a maximum likelihood error function, a mean absolute error function, or a cross-entropy function. Additionally or alternatively, the cost function may include a regularization function configured to optimize accuracy and robustness. Further, the cost function may include a neural network, such as a Bayesian Neural Network (BNN) that may account for both data-driven (e.g., aleatoric) uncertainty and model-parameter-based (e.g., epistemic) uncertainty in the nonlinear mapping function

At block 44, the processor may provide the data as an input to a mapping function. In some embodiments, the mapping function may be a linear or a nonlinear mapping function. In an embodiment where the mapping function is a nonlinear mapping function, the mapping function may include a model such as an artificial neural network (ANN). In an embodiment where the mapping function includes an ANN, the mapping function may include an activation function that, for example, may introduce nonlinearities into the mapping function. In some embodiments, the mapping function may include a nonlinear regression or classification technique of machine learning such as a support vector machine, a decision tree, an extended neural network architecture that may comprise a recurrent network, a long-short-term memory (LSTM) network, an attention model, or a combination thereof.

At block 46, the processor 30 may receiving at least one parameter characterizing the geological formation. Put differently, the processor 30 may determine a rock property output based on the mapping function, such as a nonlinear mapping function, by providing the data characterizing the concentrations as an input to the nonlinear mapping function (e.g., the parameter may be one or more rock properties). In general, the rock property output may represent or indicate one or more rock properties of the geological formation. The one or more rock properties may include matrix grain density, matrix apparent thermal neutron porosity, matrix apparent epithermal neutron porosity, matrix hydrogen index, matrix permittivity, matrix thermal-neutron absorption cross section (e.g., matrix Sigma), matrix fast-neutron elastic scattering cross section, matrix photoelectric factor, matrix permeability, cation-exchange capacity (CEC) of the matrix, electrical conductivity or resistivity of the matrix, matrix elements not otherwise measurable via wellbore spectroscopy logging, matrix heat capacity, matrix enthalpy, matrix thermal conductivity, matrix reactivity rates with an acid, matrix reactivity rates with respect to carbon dioxide in various forms, capacity for injection of carbon dioxide into the matrix, elastic moduli or other mechanical properties of the matrix, among others.

To further illustrate the method 40 and application, a dataset(s) containing the measured elemental concentrations will be represented by E (model input), and a dataset(s) containing the estimated rock properties from the method will be represented by P′ (model output). In this example, the model input and output can be vectors or scalars and the symbols E and P are taken to represent either or both. The method 40 may use suitable machine learning techniques to infer or predict P′ from E. Such examples may include, but are not limited to, an artificial neural network (ANN), decision trees, support vector machines (SVMs), Bayesian networks, and regression analysis. The prime symbol on P′ indicates that it is an algorithmic prediction of the true value(s) P.

The one or more estimated rock properties of beneficial interest include but are not limited to: matrix grain density, matrix apparent thermal neutron porosity, matrix apparent epithermal neutron porosity, matrix hydrogen index, matrix permittivity, matrix thermal-neutron absorption cross section (matrix Sigma), matrix fast-neutron elastic scattering cross section, matrix photoelectric factor, matrix permeability, cation-exchange capacity (CEC) of the matrix, electrical conductivity or resistivity of the matrix, matrix elements not otherwise measurable via wellbore spectroscopy logging, matrix heat capacity, matrix enthalpy, matrix thermal conductivity, matrix reactivity rates with an acid, matrix reactivity rates with respect to carbon dioxide in various forms, capacity for injection of carbon dioxide into the matrix, elastic moduli or other mechanical properties of the matrix, among others. These rock properties (e.g., matrix properties), individually or in combinations, are utilized to make accurate interpretations of formation characteristics in routine upstream energy workflows; one example is the use of matrix grain density to compute formation porosity from a measurement of formation bulk density.

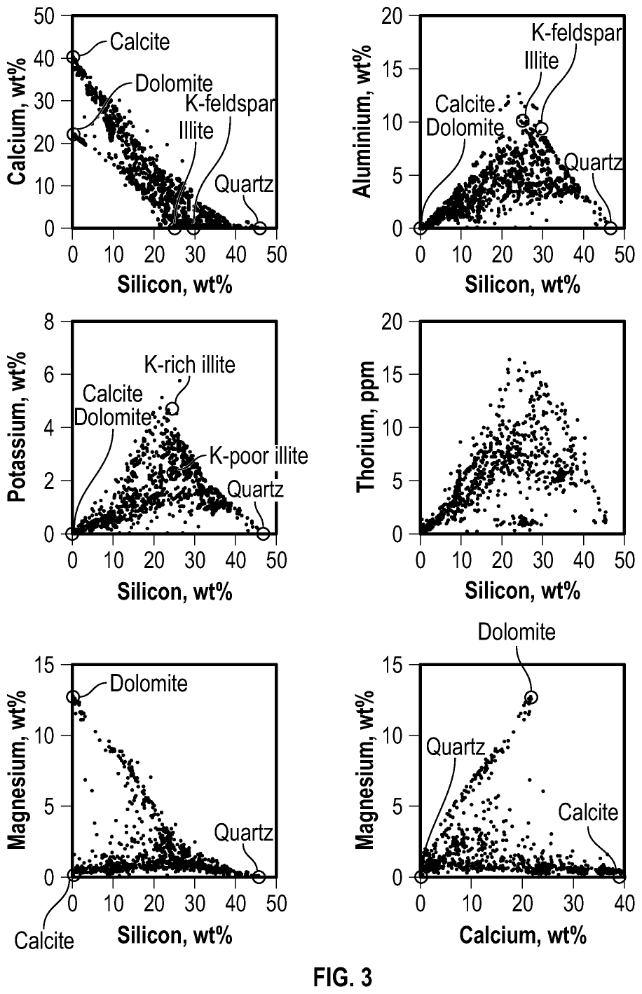

As discussed herein, certain mapping functions (e.g., a nonlinear mapping) may more accurately capture mappings that exists among the input(s) and output(s) in complex geological rock formations. Quantifiable relationships may be expected because the bulk concentrations of many elements in rock matrices may be dictated by the concentrations of minerals in the solid rock. For example, the minerals may have elemental compositions that are generally distinct from one another and that are fixed or nearly so. However, certain naturally occurring geological rock formations may contain more than two minerals such that relationships among elemental concentrations are not simple linear functions. This is illustrated in FIG. 3, which graphically represents certain relationships among elements for a set of 900 sedimentary rock samples. As indicated by FIG. 3, the prediction of one or more certain rock properties from a set of elements in that rock may be a multi-dimensional and nonlinear problem.

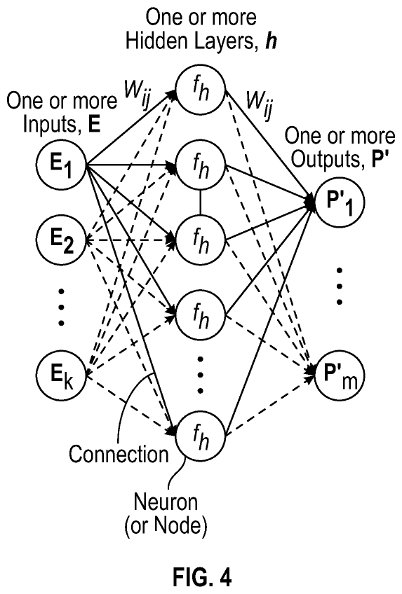

Accordingly, it may be advantageous to utilize a nonlinear mapping, such as using an ANN. FIG. 4 illustrates an architecture of an example ANN. The input E includes k number of data inputs. The hidden layers h includes some number of receiving neurons that accept input from one or more preceding neurons. The number of neurons in each hidden layer may not be the same. The first hidden layer receives input directly from E. The second and subsequent hidden layers receives input from neurons in the preceding hidden layer. The output P′ comprises m number of data outputs. The output receives input from the last hidden layer. The one or more output(s) P′ have no successors. The network includes connections that transfer the output from a one or more neurons i (predecessor) to the input of a one or more next neurons j (i.e., successor) in a succeeding layer. Each connection may have an associated weight wᵢⱼ. The network may be fully connected or connections between certain two neurons may be deactivated. The output from a neuron i is multiplied by its associated weight wᵢⱼ and the neuron j accepts the sum of multiplications transferred to it from all predecessor neurons i. The latter operation is a linear transformation and is sometimes called a propagation function. A bias term may be added to the propagation function. An activation function ƒ may be applied to change the state (i.e., value) of a neuron within a range of values constrained by that function. Activation functions are useful for introducing nonlinearities into the network, thus better capturing the nonlinear nature of the problem. The activation function may not be the same among different layers of the network, but the activation may be fixed (e.g., the same) for all neurons within a layer. Input neurons may not have activation functions.

The neural network may be trained using a feed-forward pass with activation through (hidden) layers between E and P′ where the values for the input and output are known in the training phase. A cost function (e.g., described in more detail herein) may be evaluated over the predicted values of the output P′ and the known (i.e., true) values of the output P is back-propagated to update the weights wᵢⱼ in each layer of the network. Thereafter, the values of the weights wᵢⱼ in the network can be used in the inference phase to predict an output P′ whose true values P are unknown from an input E whose values are measured or otherwise known.

In some embodiments for training a model, wherein the model is an ANN, both the input data E and the output data P should be known and accurate within accepted uncertainties to learn the mapping (e.g., network weights of the model) between the two. Once a model(s) is trained, rock properties P′ may be estimated from the input E without knowledge of the true rock properties P. In certain embodiments, data comprising E and P are rock characteristics, the true values of which are quantified using techniques known to those skilled in the art on formation samples represented by, e.g., drill core and drill cuttings. In the case of the reference inputs, elemental concentrations E may be derived from measurements using laboratory techniques including X-ray spectroscopy, such as X-ray fluorescence (XRF) spectroscopy, atomic absorption spectroscopy, mass spectrometry, neutron activation, or a combination thereof. The reference rock property or properties P may be derived from measurements using laboratory techniques (e.g., measurement of matrix grain density using helium pycnometry) or can be computed from first-principles physics (e.g., computation of matrix Sigma using known neutron cross sections of individual chemical elements).

In certain embodiments, the estimation of rock properties P′ during model inference may be derived from measurements of certain elemental concentrations E that are provided by neutron-induced gamma ray spectroscopy logging sondes, performed downhole within a borehole that traverses and is surrounded by an earth formation.

In other embodiments, in either or both training and prediction, the input data may not be the elemental concentrations themselves, but other data representation pertaining to the elemental concentrations (e.g., indirect elemental concentration data). For example, the input may be the directly measured X-ray spectrum of a formation sample because this spectrum contains the information pertaining to the identification (e.g., X-ray photon energy) and concentration (e.g., X-ray photon counts) of one or more elements in said formation. Similarly, the input could be the directly measured gamma-ray spectrum of a formation sample because in this spectrum is contained the information pertaining to the identification (gamma-ray energy) and concentration (gamma-ray counts) of one or more elements in said formation. The invented method herein is not limited to those inputs explicitly disclosed in this disclosure.

During training, a cost function may be evaluated using the predicted values P′ of the output and the known values of the output P. The weights wᵢⱼ in each layer of the network are updated via back-propagation so as to minimize the cost function. Once the weights wᵢⱼ for the entire network are optimized, the network can be used during inference to derive an estimate of a value for a one or more output P′, whose true values P are unknown, from the value of a one or more input E whose values are known (e.g., measured).

At least in some instances, uncertainties on the input data may be used in training. In general, the uncertainties indicate uncertainty in the output determined rock property. It should be noted that including uncertainties may be beneficial to build robustness to noise into the model during inference (i.e., estimation of rock property or properties values). The use of uncertainties on inputs during training can also benefit the estimation of uncertainties on the rock properties values that are output from the model during inference.

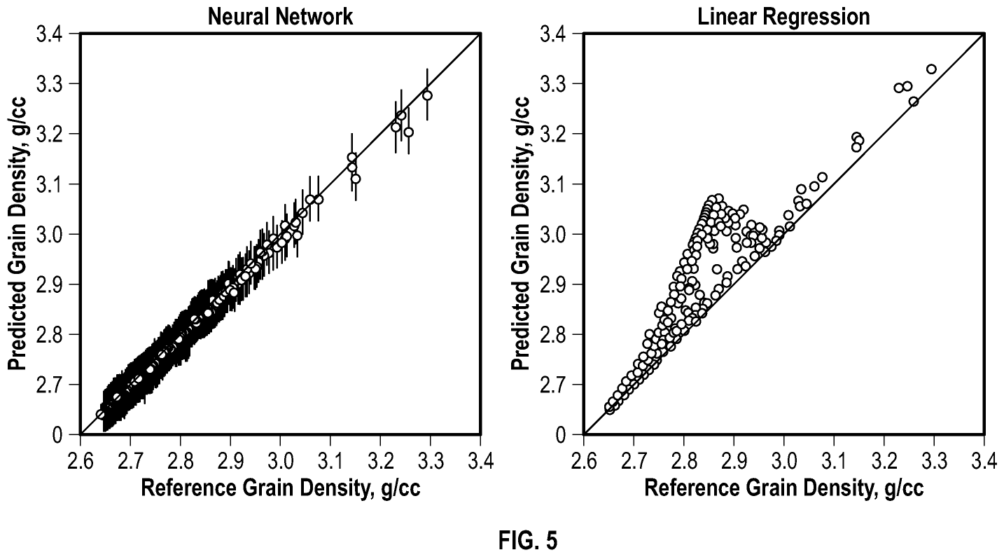

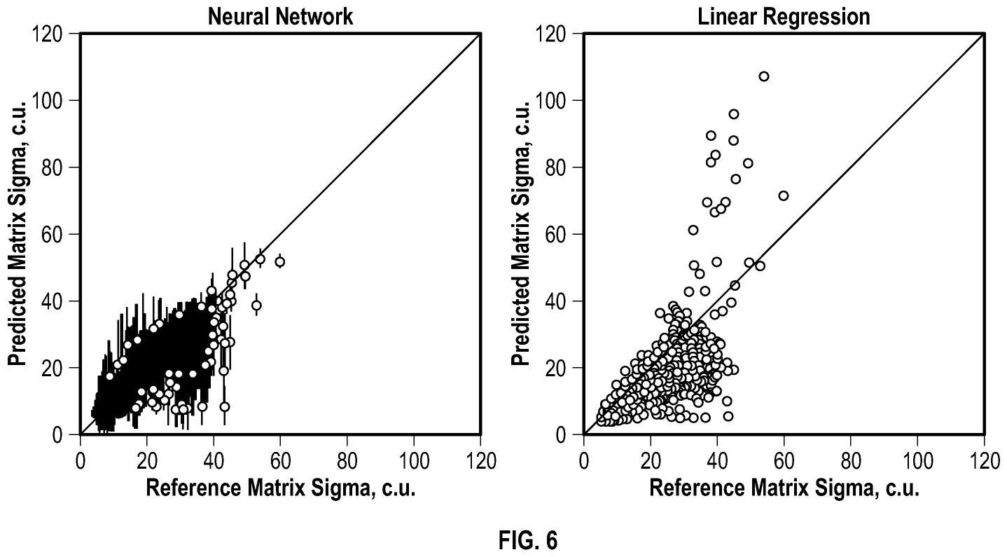

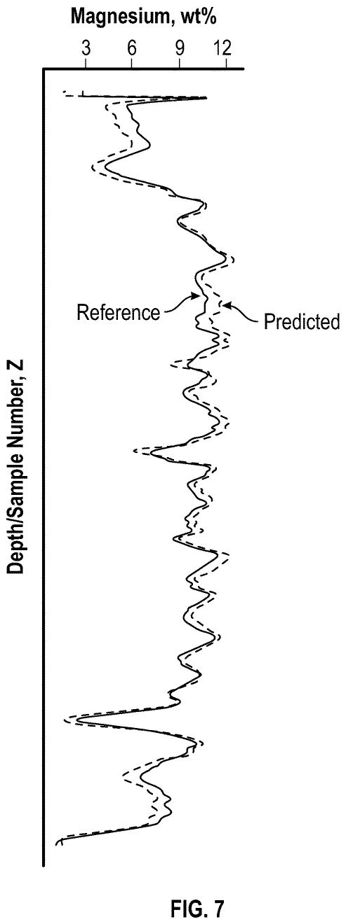

To further illustrate the disclosed techniques, FIGS. 5-7 (e.g., FIG. 5, FIG. 6, and FIG. 7) provide examples of certain rock properties that are determined based on spectroscopy data indicating elemental concentrations. Referring to FIG. 5, FIG. 5 shows plots of the matrix grain density values of a set of sedimentary rock formations estimated using the above described ANN mapping function (left plot) against their reference values. FIG. 5 also plots, for comparative purposes, the matrix grain density values of the same set of rock formations estimated using a linear regression (right plot). The ANN estimates compare favorably to their reference values and also include an estimate of uncertainty on the output property values. The ANN model approximates a global model that applies to the diverse set of sedimentary rock formations. Note how the linear regression model fails to accurate estimate the matrix grain density of a subset of the dataset, wherein the predicted matrix grain density values are higher than the true values. A single linear regression model is not sufficient to capture the multidimensional and nonlinear mappings between elements and grain density in a wide range of sedimentary rock formations. In other words, a linear regression model may require local model calibration. Nor does the linear regression model provide an inherent estimate of uncertainty. When the calculation is performed in connection with measurements of formation samples obtained from a borehole or from measurements performed by a logging device in a borehole, the calculation can provide a continuous estimate of formation matrix density as a function of depth along the borehole. Further, the calculation may be used to compute a beneficial estimate of the formation porosity, by combining the matrix grain density estimation, ρₘₐ, with measurements of formation bulk density in accordance with Eq. 4:

$$ϕ = \frac{{ρ}_{ma} - {ρ}_{b}}{{ρ}_{ma} - {ρ}_{f}} \qquad ( Eq . 4 )$$

where ϕ is porosity; ρ_{b} is bulk density measured, for example, by a density logging sonde; and ρ_{f} is fluid density. When the calculation is performed in connection with measurements of formation samples obtained from a borehole or from measurements performed by a logging device in a borehole, the calculation may provide a continuous estimate of formation porosity as a function of depth along the borehole.

As a second example, FIG. 6 shows a plot of the matrix thermal-neutron absorption cross section (matrix Sigma) values of a set of sediment rock formations estimated using the above described ANN against their reference values (left plot). FIG. 6 also plots, for comparative purposes, the matrix Sigma values of the same set of rock formations estimated using a linear regression (right plot). The ANN estimates compare favorably to their reference values and also include an estimate of uncertainty on the output property values. The ANN model reasonably approximates a global model that applies to the diverse set of sedimentary rock formations. Comparatively, the linear regression model shows larger errors between the estimated and reference matrix Sigma values than does the ANN model, including over-estimation of matrix Sigma values in formation samples with the highest reference values. When the calculation is performed in connection with measurements of formation samples obtained from a borehole or from measurements performed by a logging device in a borehole, the calculation can provide a continuous estimate of formation matrix Sigma as a function of depth along the borehole. Further, the calculation may be used to compute a beneficial estimate of the formation saturation, by combining the formation matrix Sigma estimation, Σₘₐ, with measurements of formation bulk Sigma in accordance with Eq. 5:

$${S}_{w} = \frac{( {\sum }_{b} - {\sum }_{ma} ) + ϕ ( {\sum }_{ma} - {\sum }_{hc} )}{ϕ ( {\sum }_{w} - {\sum }_{hc} )} \qquad ( Eq . 5 )$$

where S_{w} is water saturation; Σ_{b}, Σ_{hc}, Σ_{w} are, respectively, the Sigma values for the bulk formation, hydrocarbon (oil or gas), and water in the formation; and ϕ is porosity as introduced above. When the calculation is performed in connection with measurements of formation samples obtained from a borehole or from measurements performed by a logging device in a borehole, the calculation can provide a continuous estimate of water saturation as a function of depth along the borehole.

As a third example, FIG. 7 plots the estimated concentrations of a certain element, magnesium, in a set of carbonate rock formations using the described method from the measurements of a different set of elements comprising Si, Ca, Al, Fe, and S. Note that the data are derived from wellbore spectroscopy measurements and not included in the set of drill core samples used to calibrate (e.g., train) this exemplified model. The predicted and reference values are plotted as a function of depth in the borehole. The predicted concentrations of magnesium (gray data trace in FIG. 7) compare favorably to their reference concentrations (black data trace in FIG. 7). The prediction of magnesium in earth formations is beneficial in oilfield exploration and appraisal, for example, for quantifying the amount of dolomite (Mg-bearing carbonate) from calcite because these minerals have different rock properties, such as their different grain densities. It should be noted that the rock properties that can be predicted by this method are not limited to examples explicitly described, and the present disclosure should not be interpreted as limited only to the determination of the aforementioned examples.

Accordingly, the present disclosure relates to determining one or more rock properties of an earth formation based on at least one measurement of elemental concentrations in a geological formation, using machine learning (ML) techniques, such as an artificial neural network (ANN) to compute the mapping from inputs values to the desired output(s) values. At least in some instances, such as when the model inference is performed in connection with measurements of formation samples obtained from a borehole or from measurements performed by a logging device in a borehole, the techniques may provide a continuous determination of formation rock properties as a function of depth along the borehole. In certain embodiments, these rock properties include one or more of, but not limited, to matrix grain density, matrix apparent thermal neutron porosity, matrix apparent epithermal neutron porosity, matrix hydrogen index, matrix permittivity, matrix thermal-neutron absorption cross section (e.g., matrix Sigma), matrix fast-neutron elastic cross section, matrix photoelectric factor, matrix permeability, cation-exchange capacity (CEC) of the matrix, electrical conductivity or resistivity of the matrix, matrix elements not otherwise measurable via wellbore spectroscopy logging, matrix heat capacity, matrix enthalpy, matrix thermal conductivity, matrix reactivity rates with respect to acids or carbon dioxide in various forms, capacity for injection of carbon dioxide into the matrix, and elastic moduli or other mechanical properties, among other properties.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. § 112(f).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method for characterizing a geological formation comprising:
obtaining data characterizing concentrations of a set of one or more elements in the geological formation based at least in part on at least one measurement of the geological formation;
providing the data characterizing concentrations of the set of one or more elements in the geological formation as an input to a nonlinear mapping function; and
receiving, as an output, at least one parameter characterizing the geological formation, wherein the at least one parameter characterizing the geological formation represents a value of one or more rock properties of the geological formation.

2. The method of claim 1, wherein the geological formation is selected from a group consisting of a rock sample or an earth formation surrounding a borehole.

3. The method of claim 1, wherein the at least one measurement of the geological formation is selected from a group consisting of: X-ray spectroscopy, atomic absorption spectroscopy, mass spectrometry, mass spectroscopy, neutron activation, and combinations thereof.

4. The method of claim 1, wherein the at least one measurement of the geological formation is derived from spectroscopy of gamma rays induced by neutrons.

5. The method of claim 1, wherein the at least one parameter characterizing the geological formation is selected from a group comprising: matrix grain density, matrix apparent thermal neutron porosity, matrix apparent epithermal neutron porosity, matrix hydrogen index, matrix permittivity, matrix thermal-neutron absorption cross section, matrix fast-neutron elastic scattering cross section, matrix photoelectric factor, matrix permeability, cation-exchange capacity of the matrix, electrical conductivity or resistivity of the matrix, matrix chemical elements, matrix heat capacity, matrix enthalpy, matrix thermal conductivity, matrix reactivity rates with an acid, matrix reactivity rates with respect to carbon dioxide, capacity for injection of carbon dioxide into the matrix, elastic moduli or other mechanical properties, and combinations thereof.

6. The method of claim 1, wherein the set of one or more elements in the geological formation comprises at least one of: Si, Al, Ca, Mg, K, Fe, Na, Ti, P, Mn, S, Sr, Gd, B, Cl, C, O, or H.

7. The method of claim 1, wherein the nonlinear mapping function comprises an artificial neural network.

8. The method of claim 1, wherein the nonlinear mapping function comprises a nonlinear regression or classification technique of machine learning selected from a group comprising: a support vector machine, a decision tree, an extended neural network architecture that may comprise a recurrent network, a long-short-term memory (LSTM) network, an attention model, and combinations thereof.

9. The method of claim 1, wherein the data characterizing concentrations of the set of one or more elements in the geological formation comprise indirect elemental concentration data.

10. The method of claim 1, wherein the nonlinear mapping function comprises at least one activation function configured to introduce nonlinearities into the nonlinear mapping function.

11. The method of claim 1, wherein the nonlinear mapping function comprises at least one function that enables a determination of uncertainty on the at least one parameter characterizing the geological formation.

12. A non-transitory computer-readable medium comprising computer-executable instructions that, when executed by at least one processor, cause the at least one processor to perform operations comprising:
obtaining data characterizing concentrations of a set of one or more elements in a geological formation based at least in part on at least one measurement of the geological formation;
providing the data characterizing concentrations of the set of one or more elements in the geological formation as an input to a nonlinear mapping function; and
receiving, as an output, at least one parameter characterizing the geological formation, wherein the at least one parameter characterizing the geological formation represents a value of one or more rock properties of the geological formation.

13. The non-transitory computer-readable medium of claim 12, wherein the nonlinear mapping function is derived from a minimization of a cost function given a set of data comprising: input data, output data, uncertainties in the input data, missing data, and data of different fidelities as captured by their uncertainties.

14. The non-transitory computer-readable medium of claim 13, wherein the cost function is selected from a group comprising: a mean squared error function, a least squares error function, a maximum likelihood error function, a mean absolute error function, and a cross-entropy function.

15. The non-transitory computer-readable medium of claim 13, wherein the cost function comprises a regularization function configured to optimize accuracy and robustness.

16. The non-transitory computer-readable medium of claim 13, wherein the cost function is configured to account for both aleatoric uncertainty and epistemic uncertainty.

17. A system comprising:
a processor; and
a non-transitory computer-readable medium comprising computer-executable instructions that, when executed by at least one processor, cause the at least one processor to perform operations comprising:
obtaining data characterizing concentrations of a set of one or more elements in a geological formation based at least in part on at least one measurement of the geological formation;
providing the data characterizing concentrations of the set of one or more elements in the geological formation as an input to a nonlinear mapping function; and
receiving, as an output, at least one parameter characterizing the geological formation, wherein the at least one parameter characterizing the geological formation represents a value of one or more rock properties of the geological formation.

18. The system of claim 17, wherein the nonlinear mapping function comprises a Bayesian Neural Network (BNN) is configured to account for both aleatoric uncertainty and epistemic uncertainty.

19. The system of claim 17, wherein the set of one or more elements in the geological formation comprises at least one of: Si, Al, Ca, Mg, K, Fe, Na, Ti, P, Mn, S, Sr, Gd, B, Cl, C, O, or H.

20. The system of claim 17, wherein the at least one parameter characterizing the geological formation is selected from a group comprising: matrix grain density, matrix apparent thermal neutron porosity, matrix apparent epithermal neutron porosity, matrix hydrogen index, matrix permittivity, matrix thermal-neutron absorption cross section, matrix fast-neutron elastic scattering cross section, matrix photoelectric factor, matrix permeability, cation-exchange capacity of the matrix, electrical conductivity or resistivity of the matrix, matrix chemical elements, matrix heat capacity, matrix enthalpy, matrix thermal conductivity, matrix reactivity rates with an acid, matrix reactivity rates with respect to carbon dioxide, capacity for injection of carbon dioxide into the matrix, elastic moduli or other mechanical properties, and combinations thereof.
